(19) United States
(12) Patent Application Publication
(10) Pub. No.: US 2025/0367589 A1
(43) Pub. Date: Dec. 4, 2025

(54) Sorption Module, System, And Method For Separating Carbon Dioxide From A Gas Stream

(71) Applicant: Volkswagen Aktiengesellschaft, Wolfsburg (DE)

(72) Inventors: Martin HOFER, Braunschweig (DE); Marcel WIEGEL, Gardelegen / OT Sachau (DE); Peter KAWELKE, Wolfsburg (DE); Frank BEGER, Hannover (DE); Christian HEIMERMANN, Wolfsburg (DE)

(73) Assignee: Volkswagen Aktiengesellschaft, Wolfsburg (DE)

(21) Appl. No.: 19/214,601

(22) Filed: May 21, 2025

(30) Foreign Application Priority Data
May 29, 2024 (DE) 102024115077.7

(51) Int. Cl. B01D 53/04

(52) U.S. Cl. CPC B01D 53/0446; B01D 2253/108; B01D 2253/34; B01D 2257/504; B01D 2257/80; B01D 2258/06

(57) ABSTRACT

The disclosure relates to a sorption module for sorption of carbon dioxide from the ambient air. The sorption module comprises a housing with at least one inlet opening and at least one outlet opening, a sorbent bed support arranged in the housing, which supports a plurality of sorbent beds filled with a sorbent material, and closure flaps for closing the at least one inlet opening and the at least one outlet opening in the housing of the sorption module. The closure flap is configured to homogenize the flow to the different sorbent beds in the sorption module.

### CROSS-REFERENCE TO RELATED APPLICATIONS

This application claims priority to German Patent Application DE 10 2024 115 077.7, filed on May 29, 2024 with the German Patent and Trademark Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to a sorption module for separating carbon dioxide from a gas stream, in particular from an air stream, to a system for separating carbon dioxide from the ambient air with such a sorption module, and to a method for separating carbon dioxide with such a sorption module according to the preamble of the independent patent claims.

Systems and methods for separating carbon dioxide from the ambient air are known to the inventors. Such separation can be carried out using what is known as the “direct air capture process,” wherein the carbon dioxide can be separated directly from the ambient air, stored or fed into a further process. Carbon dioxide can be separated from the ambient air using different sorbents. Typically, chemisorbents and/or physisorbents are used to separate carbon dioxide. Amine-based chemisorbents have the problem of aging and degradation when the material comes into contact with oxygen at temperatures above approx. 60° C. This can occur during the desorption phase at temperatures of around 100° C. if countermeasures are not implemented, for example an inert atmosphere in the system using water vapor or other gases. These protective measures are laborious and expensive. Physisorbents, such as zeolites, have the problem that the affinity of the sorbent material for water (vapor) is higher than for carbon dioxide, which means that the ambient air must first be dried before being supplied to an adsorption space in which the zeolite material is arranged. Drying the air in this way is also laborious and expensive.

In order to achieve efficient separation of carbon dioxide from the ambient air, systems for the separation of carbon dioxide may be operated using renewable energies, in particular hydropower, wind power, geothermal energy or solar energy. Operation with hydropower would be beneficial, as this can be provided continuously and reliably. However, the potential for generating energy from hydropower is limited to corresponding watercourses and is already almost fully utilized in many regions, such that an expansion of the use of hydropower is limited. Solar energy and wind power can essentially be used regardless of location, but their use is limited by the orbit of the sun and/or the weather conditions at the location.

A disadvantage of such systems, however, is that the adsorption and desorption processes for carbon dioxide and any drying process of the ambient air upstream of the adsorption are influenced by different parameters, such as the ambient temperature, humidity, temperature and carbon dioxide content of the ambient air.

Furthermore, such systems can only adsorb the carbon dioxide from the ambient air efficiently if the air flows through the sorbent material as completely and homogeneously as possible. For efficient separation of carbon dioxide, it is therefore helpful if the largest possible inflow surface can be realized in the smallest possible volume.

### SUMMARY

A need exists to improve the adsorption and subsequent desorption of carbon dioxide in a sorption module and thereby improve the efficiency of a system for separating carbon dioxide from the ambient air.

The need is addressed by the subject matter of the independent claim(s). Embodiments of the invention are described in the dependent claims, the following description, and the drawings.

### BRIEF DESCRIPTION OF THE DRAWINGS

FIG. 1 shows an example system for separating carbon dioxide with a sorption module;

FIG. 2 shows an embodiment of a sorption module in a three-dimensional representation;

FIGS. 3, 3A-3F shows an embodiment of a sorption module;

FIG. 4 shows a section through an example sorption module;

FIG. 5 shows an embodiment of a sorbent bed support with a plurality of sorbent beds as well as inlet and outlet channels;

FIG. 6 shows another embodiment of a sorbent bed support with a plurality of sorbent beds;

FIG. 7 shows a schematic representation of an example closure flap with a flap support for closing an inlet opening or outlet opening of a housing of the sorption module;

FIG. 8 shows a further section through an example sorption module; and

FIG. 9 shows an example flow chart for carrying out a method for separating carbon dioxide from a gas stream with such a sorption module.

### DESCRIPTION

The details of one or more embodiments are set forth in the accompanying drawing and the description below. Other features will be apparent from the description, drawing, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments, a sorption module is provided that comprises a housing with at least one inlet opening and at least one outlet opening, a sorbent bed support arranged in the housing, which supports a plurality of sorbent beds filled with a sorbent material, and closure flaps for closing the at least one inlet opening and the at least one outlet opening in the housing of the sorption module. It is noted that in the context of the present discussion, the terms ‘sorption module’ and ‘sorption subassembly’ are used interchangeably.

In some embodiments, it is provided that, in a first operating state, a gas stream flows through the sorption module, wherein the carbon dioxide is adsorbed in the sorbent material of the sorbent beds, and in a second operating state, the sorption module is closed by the closure flaps, wherein the carbon dioxide is desorbed.

This can improve the efficiency of the separation of carbon dioxide from a gas stream and reduce the energy required for separation. In particular, the adsorption and desorption in the sorbent beds can achieve a uniform absorption of carbon dioxide, so that premature saturation of one sorbent bed with simultaneous low saturation of another sorbent bed is avoided.

In some embodiments, it is provided that the housing is designed as a cylindrical housing or a housing with a cylindrical portion. A cylindrical housing is particularly favorable for withstanding negative pressure in the desorption phase. With a cylindrical shape, there is no need for additional support structures, which lead to additional flow resistance with other geometries.

The cylindrical housing has for example a length to diameter ratio in the range of 1.5-to-1 to 3-to-1. Tests have shown that such a dimension is favorable with regard to the number and size of the sorbent beds and the flow through the sorbent beds for the most efficient separation of carbon dioxide.

The housing has for example a diameter of 1.5 to 5 m, or for example 2 to 3 m, or for example 2.2 m to 2.7 m and a length of 2 to 10 m, or for example 3 to 7 m, or for example 4 to 6 m. With these dimensions, a particularly efficient separation of carbon dioxide is possible with a very low flow resistance and thus correspondingly favorable operating parameters.

In some embodiments, it is provided that the inlet opening is arranged on a first side of a lateral surface of the housing and the outlet opening is arranged on an opposite second side of the lateral surface. This ensures a simple flow through the sorption module with low flow resistance. In this process, the gas flows against all sorbent beds essentially uniformly and the sorbent beds are uniformly loaded with carbon dioxide.

In some embodiments, it is provided that the sorption module comprises a flow deflector (element) for manipulating a gas stream through the sorption module, wherein the flow deflector is configured to homogenize the flow to the different sorbent beds in the sorption module. In other words, the flow deflector is configured to achieve the most uniform flow possible to the sorbent beds. The sorption module thus enables the largest possible inflow surface for the sorption beds with the lowest possible inflow loss or, respectively, flow resistance when the gas flows through the sorption module. This can improve the efficiency of the separation of carbon dioxide from a gas stream and reduce the energy required for separation. In particular, the uniform flow to the sorbent beds improves the absorption of carbon dioxide from the gas stream, so that the sorbent beds are uniformly loaded with carbon dioxide and one sorbent bed is not already saturated while another sorbent bed has only a low load.

In some embodiments, a flap support and at least one pivoting flap for controlling a gas stream through the sorption module are provided upstream of a flow deflector. This makes it easy to close the sorption module.

In some embodiments, it is provided that inlet channels fluidically connected to the inlet opening are formed between the sorbent beds and taper in the direction of flow starting from the inlet opening in the direction of the outlet opening. This can promote uniform gas passage through the sorbent beds, enabling particularly efficient separation of carbon dioxide.

In some embodiments, the inlet channels are closed as completely as possible at their end facing the outlet opening. This forces the gas to pass through the sorbent beds, so that a gas stream conducted through the sorption module not only brushes along the surface of the sorbent beds, but also passes through the sorbent beds, binding the carbon dioxide to or in the sorbent material of the sorbent beds in the process.

In some embodiments, it is provided that two sorbent beds lying one above the other are arranged parallel to each other. This enables the sorbent beds to be aligned horizontally, allowing the sorbent material to be introduced into the sorbent beds as a simple fill.

Alternatively, it is beneficial for two adjacent sorbent beds to be arranged at an angle of 2° to 10°, or for example 2.5° to 7.5°, or for example 3° to 6° to each other. The slightly inclined arrangement of the sorbent beds simplifies the formation of inlet channels that taper in the direction of flow and outlet channels that widen in the direction of flow between the sorbent beds, which promotes a uniform passage of the gas stream through the sorbent bed.

In some embodiments, it is provided that a filler, also referred herein as a ‘filling element’, is arranged in an edge region of the housing, which prevents gas from flowing into the edge region of the housing. This can minimize a contaminated volume in the sorption module in which no adsorption and/or desorption of carbon dioxide takes place. This can increase the ratio of sorbent volume to total volume of the sorption module and improve the efficiency of the sorption module.

In some embodiments, it is provided that the sorbent bed support has a height corresponding to one to two times, for example 1.2 to 1.8 times, or for example 1.3 to 1.7 times its width. Such a ratio of height to width of the sorbent bed support results in particularly favorable flow conditions with regard to the homogeneity of the flow through the sorbent beds and the pressure loss or, respectively, flow resistance when the gas flows through the sorption module.

In some embodiments, it is provided that the sorbent material is spherical and is present as fill in the sorbent beds. This allows the sorbent material to be introduced into a sorbent bed particularly easily and cost-effectively. The spherical shape also ensures that the sorbent material is uniformly distributed in the sorbent beds, thus achieving the most homogeneous fill possible in the sorbent beds.

In some embodiments, the fill is fixed in or on the sorbent bed by a fixing agent. For example in the case of a planned inclined position of the sorbent beds, it may be beneficial if the fill is fixed in or on the sorbent bed by a fixing agent in order to prevent sorbent material from falling out of the sorbent bed in the inclined position. It may be also beneficial in some embodiments to fix the sorbent material in or on the sorbent bed in order to prevent the sorbent material from being blown away when the gas stream passes through the sorbent material.

A further aspect of the disclosure relates to a system for separating carbon dioxide from the ambient air. The system comprises a dryer, also referred herein as a ‘drying unit’, a sorption unit, also referred to herein as a ‘sorption assembly’ or ‘sorption enclosure’, and a conveyor, also referred herein as a ‘conveying element’, for conveying a gas stream, in particular a stream of air, through the system, wherein the sorption unit has one or for example a plurality of sorption modules described herein. Such a system enables particularly efficient separation of carbon dioxide from a gas stream, as carbon dioxide is separated particularly efficiently in the sorption module.

The system may additionally comprise a storage (unit) for receiving the separated carbon dioxide in order to store the carbon dioxide separated in the sorption unit. Alternatively, the separated carbon dioxide can also be further processed in a subsequent operation.

A further aspect of the disclosure relates to a method for separating carbon dioxide from a gas stream, in particular from a stream of ambient air, using a sorption module described herein, which comprises:
Conducting a gas stream through an inlet opening into the housing of the sorption module,
Adsorbing the carbon dioxide contained in the gas stream,
Closing the closure flaps in the housing of the sorption module, and
Desorbing the carbon dioxide bound in the sorbent material.

The method enables the efficient separation of carbon dioxide, as the largest possible inflow surfaces for the sorption beds can be realized with the lowest possible inflow loss or, respectively, flow resistance when the gas flows through the sorption module. This can improve the efficiency of the separation of carbon dioxide from a gas stream and reduce the energy required for separation. In particular, the uniform flow to the sorbent beds improves the absorption of carbon dioxide from the gas stream, so that the sorbent beds are uniformly loaded with carbon dioxide and one sorbent bed is not already saturated while another sorbent bed has only a low load.

In some embodiments of the method, it is provided that the gas stream is manipulated by the sorption module. The gas stream is diverted and/or divided in such a way that the flow through the sorbent beds is as uniform as possible.

In some embodiments of the method, it is provided that a gas stream, in particular a stream of air, is conducted through a sorbent bed from a bottom side to a top side or from a top side to a bottom side. By passing the gas through the sorbent bed, a particularly efficient separation of carbon dioxide is achieved, which increases the yield of carbon dioxide and improves the energy efficiency of the system.

Reference will now be made to the drawings in which the various elements of embodiments will be given numerical designations and in which further embodiments will be discussed.

Specific references to components, process steps, and other elements are not intended to be limiting. The FIGS. Are schematic and not necessarily to scale.

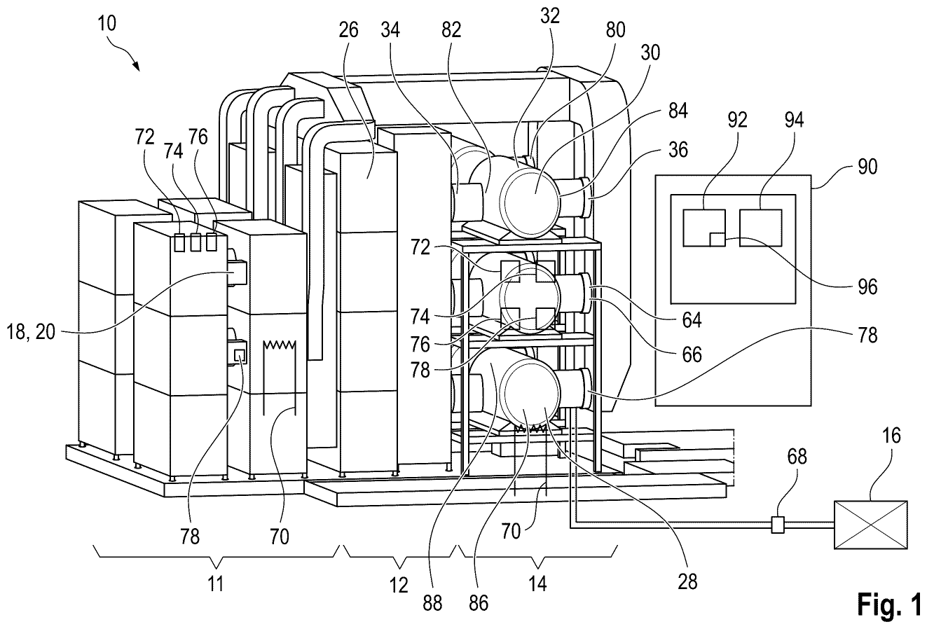

FIG. 1 shows a system 10 for separating carbon dioxide from a gas stream, in particular from the ambient air. A gas stream with a certain residual moisture content is fed into the system 10 and carbon dioxide and water are extracted from this gas stream. An exhaust air stream, which has a partially dried, carbon-dioxide-reduced gas compared to the incoming gas, flows out of the system 10. The system 10 comprises a preconditioning unit 11, in which a gas stream is filtered and pre-dried. For this purpose, the preconditioning unit 11 contains at least one filter unit and one drying unit in order to prepare a gas stream for further processing in the system 10. Furthermore, the preconditioning unit 11 contains a conveying element 18, in particular a blower 20, to generate such a gas stream and to convey the ambient air through the system 10.

The system 10 also comprises a drying unit 12, in which the residual moisture contained in the gas stream is at least partially extracted. For example, a hydrophilic material such as silica gel can be used as a drying agent for the drying unit 12. In principle, any drying material that is suitable for absorbing moisture from the air can be used. In particular, a sorbent material 22, in particular a physisorbent 23, can also be provided as a drying agent in the drying unit 12. For example, a drying agent is used which is regenerated by appropriate process control after absorbing the humidity and is therefore available for the process again. The aim is to achieve a degree of drying of the gas stream at which the residual moisture in the air has a dew point of at most −30° C., or for example −50° C., or for example at most a dew point of −60° C.

The system 10 also comprises a sorption unit 14, in which the carbon dioxide from the gas stream, in particular from the ambient air, is bound. The carbon dioxide in the dried gas stream is stored in a sorbent material 22, in particular in a physisorbent 23, particularly for example in a zeolite material 24. The sorption unit 14 comprises one or more sorption modules 30, each of which has a cylindrical housing 32. Alternatively, the sorption modules 30 can also have geometries that deviate from a cylindrical shape. The housing 32 has a lateral surface 80, wherein at least one inlet opening 34 is formed on a first side 82 of the lateral surface 80 and at least one outlet opening 36 is formed on a second side 84 of the lateral surface 80 opposite the first side 82.

In addition, the system 10 has a storage unit 16 in which the carbon dioxide separated from the gas stream in the sorption unit 14 is stored in concentrated form. The system 10 further comprises a conveying element, in particular a blower, with which a gas stream, in particular a stream of air, is passed through the drying unit and then through the sorption unit 14.

For example, the gas stream is dried in a first process space 26, which can be separated from the environment in a substantially gas-tight manner by closure elements, in particular by closure flaps 46, 64. In the exemplary embodiment shown, the first process space 26 has an inlet flap 46 and an outlet flap 64. A heating element 70 can be arranged in the first process space 26 in order to manipulate the temperature of the drying material in the drying unit 12 or, respectively, in the first process space 26. Furthermore, sensors 72, 74, 76, 78, 79 for detecting a temperature, a pressure, a carbon dioxide concentration, a flow velocity and/or a relative or absolute moisture of the gas stream can be arranged in the first process space 26 or, respectively, in the drying unit 12.

The adsorption and subsequent desorption of carbon dioxide for example takes place in a second process space 28, which can be separated from the environment in a substantially gas-tight manner by closure elements 46, 64, in particular by flaps 46, 64. Furthermore, the second process space 28 has a heating element 70, in particular a heat exchanger, in order to be able to raise the temperature accordingly, in particular during the desorption process, and to release the carbon dioxide adsorbed in the sorption material 22. A vacuum pump 68 can be provided at the second process space 28 or, respectively, at the sorption unit 14 in order to manipulate the air pressure in the second process space 28 or a gas line connecting the second process space 28 to the storage unit 16 and, in particular, to lower it during a desorption process. The second process space 28 is fluidically connected to the storage unit 16, in which the carbon dioxide separated from the ambient air can be stored. A temperature sensor 72, a pressure sensor 74, a humidity sensor 79, a sensor for detecting the carbon dioxide concentration 76, a sensor 78 for detecting the flow velocity, a mass flow sensor and/or a volume flow sensor are arranged in the second process space 28 or, respectively, in the sorption unit 14.

A conveying element 18, in particular a blower 20, is integrated into the preconditioning unit 11 in order to convey a gas stream, in particular a stream of the ambient air, first through the preconditioning unit, then through the drying unit 12 and then through the sorption unit 14. The conveying element 18 has a drive unit, the power of which can be adjusted accordingly via a power control. Alternatively, the conveying element can also be arranged at other positions in the system 10, in particular in a channel for supplying the air to the system 10 or a channel for discharging the air from the system 10.

The system 10 is for example supplied with electricity from renewable energies such as wind power or solar energy, so as not to generate any additional carbon dioxide emissions during operation. For this purpose, a wind turbine and/or a solar system, in particular a solar thermal system or a photovoltaic system, is provided to supply the system with renewable energy.

The system 10 also has a control unit 90 with a storage unit 92 and a computing unit 94, wherein a computer program code 96 is saved in the storage unit 92 and is configured, when executed by the computing unit 94 of the control unit 90, to control the operation of the system 10 for separating carbon dioxide from the gas stream, in particular from the ambient air. The control unit 90 can be connected to a data center via a data connection, which data center provides the system 10 with data for controlling the system 10 or exchanges data with it.

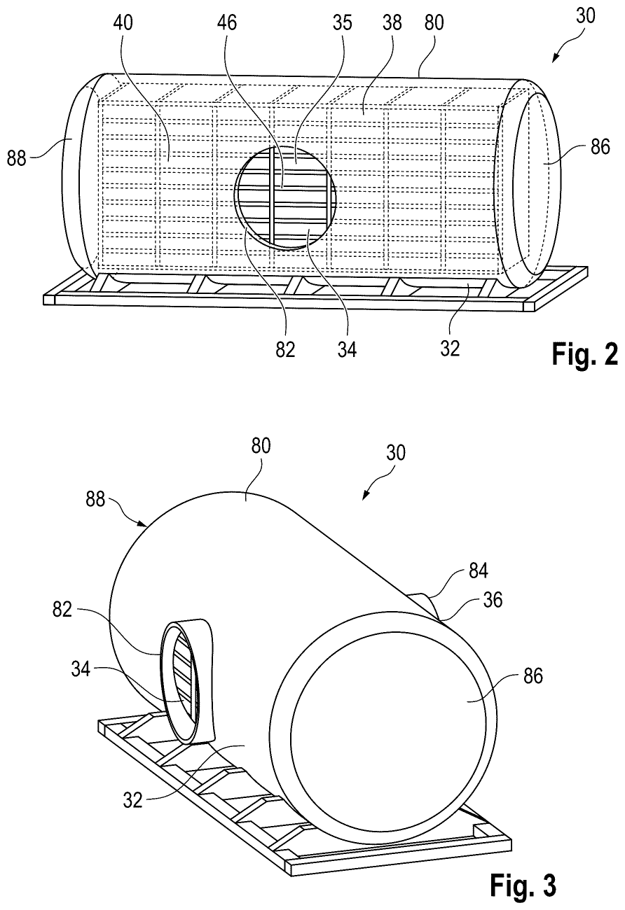

FIG. 2 shows an exemplary embodiment of a sorption module 30 according to the teachings herein in a three-dimensional representation. The sorption module 30 has a cylindrical housing 32 with a lateral surface 80, a first end face 86 and a second end face 88 opposite the first end face 86. An inlet opening 34, through which a gas stream can enter the housing 32 of the sorption module, is formed on a first side 82 of the lateral surface 80. A flow deflector 47 can be provided at the inlet opening 34, with which flow deflector element a gas stream can be deflected and/or divided by the sorption module 30 in order to achieve as uniform a flow as possible to the different sorbent beds 38 in the sorption module 30.

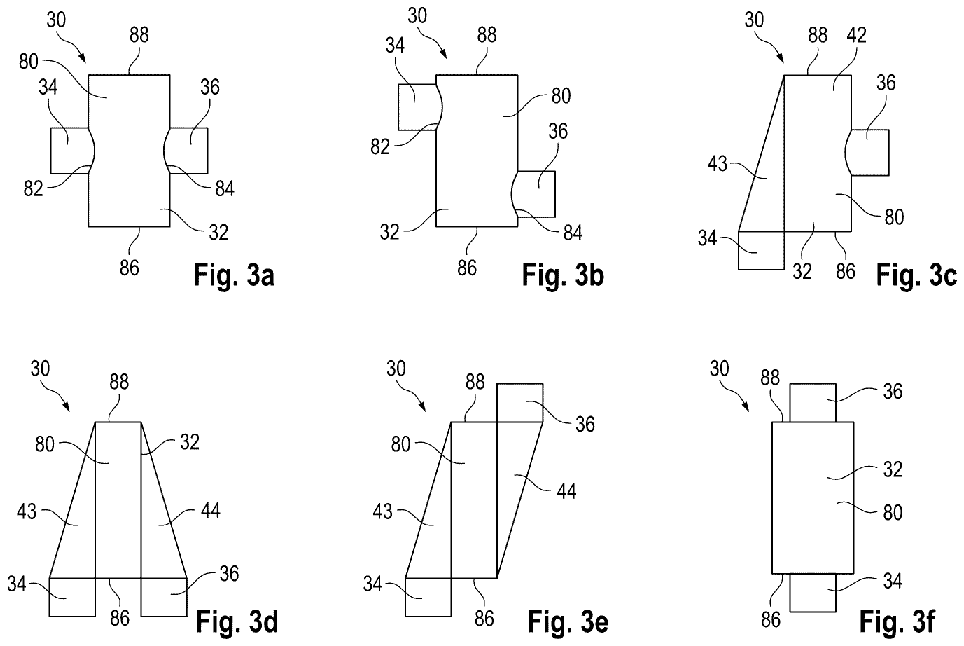

FIGS. 3a to 3f show different exemplary embodiments of a sorption module 30 according to the. FIG. 3a shows a sorption module 30 with one inlet opening 34 and one outlet opening 36, which are arranged on opposite sides 82, 84 of a lateral surface of a cylindrical housing 32 of the sorption module 30. In this case, the inlet opening 34 and the outlet opening 36 are arranged in alignment with one another and centrally on opposite sides 82, 84 of the lateral surface 80.

FIG. 3b shows a sorption module 30 with one inlet opening 34 and one outlet opening 36, which are arranged on opposite sides 82, 84 of a lateral surface 80 of a cylindrical housing 32 of the sorption module 30. In this case, the inlet opening 34 and the outlet opening 36 are arranged diagonally offset from each other on opposite sides 82, 84 of the lateral surface 80.

FIG. 3c shows a sorption module 30, which has a housing 32 with a cylindrical part 42 and an inlet region 43 upstream of the cylindrical part 42. In this case, the inlet opening 34 at the inlet region 43 and the outlet opening 36 at the cylindrical part 42 are at right angles to each other, so that a gas stream passing through the sorption module 30 is deflected by 90° between the inlet opening 34 and the outlet opening 36.

FIG. 3d shows a sorption module 30, which has a housing 32 with a cylindrical part 42 as well as an inlet region 43 upstream of the cylindrical part 42 and an outlet region 44 downstream of the cylindrical part 42. The inlet opening 34 at the inlet region 43 and the outlet opening 36 at the outlet region 44 are rotated by 180° relative to each other, so that a gas stream passing through the sorption module 30 is deflected by 90° between the inlet opening 34 and the cylindrical region 42 and by another 90° between the cylindrical region and the outlet opening 36 at the outlet region 44.

FIG. 3e shows a further embodiment of a sorption module 30, which has a housing 32 with a cylindrical part 42 and an inlet region 43 upstream of the cylindrical part 42 and an outlet region 44 downstream of the cylindrical part 42. The inlet opening 34 at the inlet region 43 and the outlet opening 36 at the outlet region 44 are diagonally offset from one another, so that a gas stream passing through the sorption module 30 is passed diagonally through the cylindrical region 42 between the inlet opening 34 and the outlet opening 36 and is deflected accordingly in the process.

FIG. 3f shows a further exemplary embodiment of a sorption module 30, in which an inlet opening 34 is formed on a first end face 86 of a cylindrical housing 32 and an outlet opening 36 is formed on a second end face 88 opposite the first end face 86. In this case, the gas flows through the cylindrical housing 32 in the longitudinal direction.

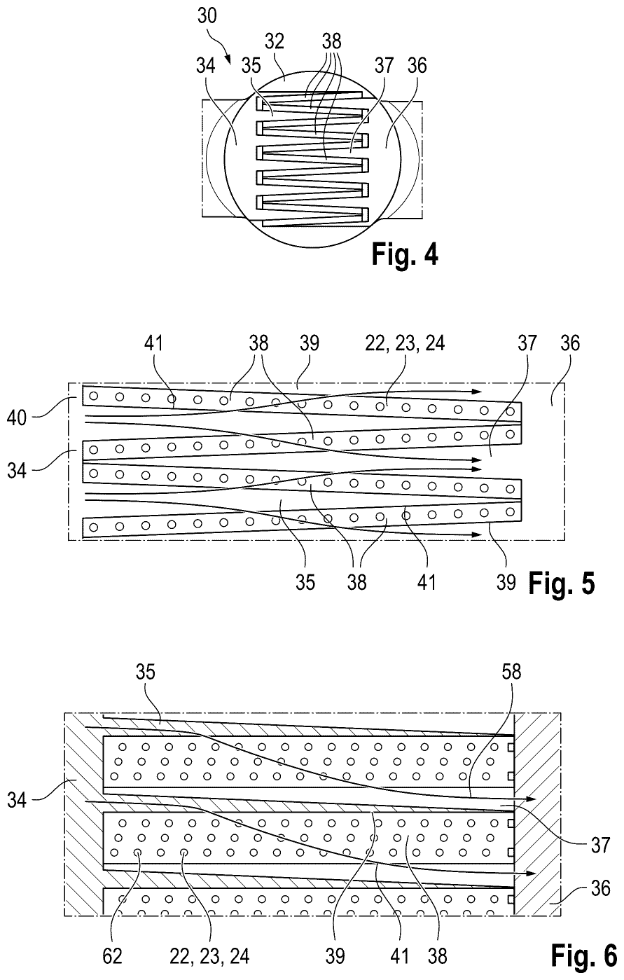

FIG. 4 shows a section through a sorption module 32. The sorption module 30 has a cylindrical housing 32, on which an inlet opening 34 and an outlet opening 36 are formed. A process space 28 is formed in the cylindrical housing 32, in which process space a sorbent bed support 40 is arranged, which supports a plurality of sorbent beds 38. Starting from the inlet opening 34, inlet channels 35 formed between the sorbent beds 38 extend in the direction of the outlet opening 36, through which inlet channels a gas stream is passed, which passes through a sorbent bed 38 and then flows out again through an outlet channel 37, which is fluidically connected to the outlet opening 36. As it passes through the sorbent bed 38, the carbon dioxide contained in the gas stream is bound in the sorbent material 22 of the sorbent bed 38.

FIG. 5 shows an embodiment of a sorbent bed support 40 with a plurality of sorbent beds 38 as well as inlet and outlet channels 35, 37, which are formed between the sorbent beds 38. In this case, the inlet channels 35 are tapered in the direction of flow, as the gas stream is to be passed uniformly through the sorbent material 22 in the sorbent beds 38 and a lower height of the inlet channel 35 is required in the rear region for this purpose. A gas stream fed through the inlet channel 35 is divided and passed proportionally through each of the sorbent beds 38. The gas flows through the sorbent beds 38 stacked in the sorbent bed support 40 alternately from top to bottom and from bottom to top. In this exemplary embodiment, the sorbent beds 38 are arranged slightly inclined at a slight angle of 1 to 5° to the horizontal or, respectively, 2 to 10° to the neighboring sorbent bed 38, so that the inlet channels 35 taper in the direction of flow due to the design. It is also possible that the inlet channels are completely closed at their end facing the outlet opening in order to promote or, respectively, force the passage of the gas stream through the sorbent beds 38. No additional partition walls are required.

FIG. 6 shows an embodiment of a sorbent bed support 40 with a plurality of sorbent beds 38 as well as inlet and outlet channels 35, 37, which are formed between the sorbent beds 38. In this case, the inlet channels 35 are tapered in the direction of flow, as the gas stream is to be passed uniformly through the sorbent material 22 in the sorbent beds 38 and a lower height of the inlet channel 35 is required in the rear region for this purpose. In the exemplary embodiment example shown in FIG. 6, the sorbent beds 38 are aligned horizontally. The gap between two sorbent beds 38 contains one inlet channel 35 and one outlet channel 37, which are separated from each other by a partition plate.

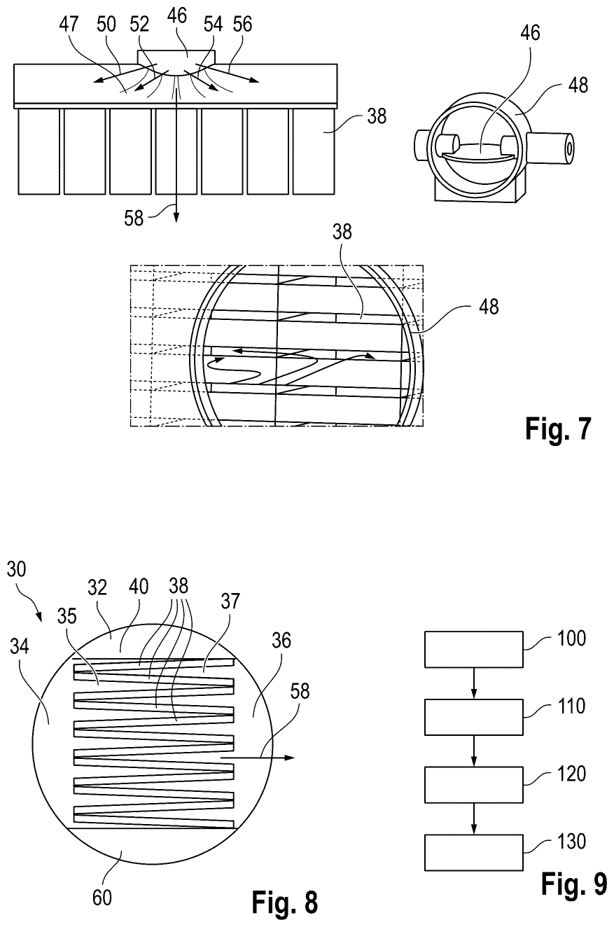

FIG. 7 shows an inlet opening 34 with a schematic representation of a flap support 48 with a closure flap 46. In addition, a flow deflector 47 can be present to distribute the gas stream within the sorption module 30 and support the deflection or, respectively, division of the gas stream entering through the flap support 48 and the open closure flap 46 in order to achieve an even more uniform flow through the sorbent beds of the sorption module 30 and to reduce the flow losses. The flow deflector 47 is configured to ensure as uniform a flow as possible to all sorbent beds 38 over the entire length of the sorption module 30 and thus ensure the most efficient possible adsorption of carbon dioxide from the gas stream. In this case, the flow deflector 47 and the inlet opening 34 are arranged or, respectively, formed as centrally as possible on a first side 82 of a lateral surface 80 of the housing 32 of the sorption module. This allows the gas stream to be divided uniformly over the length of the sorption module 30, starting from the inlet opening. Alternatively, two inlet openings 34 can also be provided, whereby more inlet openings increase the design effort required to seal the sorption module 30. Ideally, the inlet openings 34 are connected to each other in the longitudinal direction of the cylinder, as the flow can be distributed even better in the sorption module 30 with such a connection and the gas flows through the sorbent beds 38 even more uniformly.

FIG. 8 shows a sorbent bed support 40 with a plurality of sorbent beds 38. In order to achieve as homogeneous a flow as possible through the sorbent beds 38, a height of the sorbent bed support 40 is provided which corresponds to one to two times, for example 1.2 times to 1.8 times, or for example 1.3 times to 1.7 times the width of the sorbent bed support 40. Such a ratio of height to width of the sorbent bed support 40 results in particularly favorable flow conditions with regard to the homogeneity of the flow through the sorbent beds 38 and the pressure loss or, respectively, flow resistance when the gas flows through the sorption module. For example, a seal between the inlet side and outlet side takes place at the outlet-side end of the sorbent bed support 40 or, respectively, the end of the sorbent beds 38 facing the outlet side, so that the inlet channels can be connected in the longitudinal direction of the cylinder. This promotes the uniform flow through all sorbent beds 38.

FIG. 9 shows a flow chart for carrying out a method for separating carbon dioxide from a gas stream, in particular a stream of air.

In a first method step <100>, an inlet opening 34 and an outlet opening 36 of the housing 32 of the sorption module are opened. In a method step <110>, a gas stream is conducted through the inlet opening 34 into the housing 32 of the sorption module 30, wherein the carbon dioxide contained in the gas stream is adsorbed in the sorbent material 22 of the sorption module 34 before the remaining gas leaves the sorption module 34 through the opened outlet opening 36. In a method step <120>, the closure flaps 46, 64 are closed and the inlet openings 34 and outlet openings 36 in the housing 32 of the sorption module 30 are closed. In a method step <130>, the sorption module 30 is heated and for example the pressure in the sorption module 30 is reduced in order to desorb the carbon dioxide bound in the sorbent material 22 during adsorption.

### LIST OF REFERENCE NUMERALS

10 System for separating carbon dioxide
11 Preconditioning unit/Preconditioner
12 Drying unit/Dryer
14 Sorption unit/Sorption enclosure
16 Storage unit/Storage
18 Conveying element/Conveyor
20 Blower
22 Sorbent material
23 Physisorbent
24 Zeolite
26 First process space
28 Second process space
30 Sorption module/Sorption subassembly
32 Housing
34 Inlet opening
35 Inlet channel
36 Outlet opening
37 Outlet channel
38 Sorbent bed
39 Top side
40 Sorbent bed support
41 Bottom side
42 First cylinder side
43 Inlet region
44 Outlet region
46 Closure flap
47 Flow deflector
48 Flap support
50 Flow arrow
52 Flow arrow
54 Flow arrow
56 Flow arrow
58 Direction of flow
60 Filling elements/Filler
62 Spheres (of the sorbent material)
64 Outlet flap
66 Sealing element
68 Vacuum pump
70 Heating element/Heater
72 Temperature sensor
74 Pressure sensor
76 Sensor for detecting the carbon dioxide concentration
78 Sensor for detecting the flow velocity
79 Humidity sensor
80 Lateral surface
82 First side of the lateral surface
84 Second side of the lateral surface
86 First end face
88 Second end face
90 Control device/Processor
92 Storage unit/Storage
94 Computing unit/Computer
96 Computer program code

The invention has been described in the preceding using various example embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the functions of several items recited in the claims.

The term “exemplary” used throughout the specification means “serving as an example, instance, or exemplification” and does not mean “preferred” or “having advantages” over other embodiments. The terms “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1. A sorption module for sorption of carbon dioxide from the ambient air, comprising:
a housing with at least one inlet opening and at least one outlet opening;
a sorbent bed support arranged in the housing, which supports a plurality of sorbent beds filled with a sorbent material;
and closure flaps for closing the at least one inlet opening and the at least one outlet opening in the housing of the sorption module.

2. The sorption module of claim 1, wherein the housing is configured as a cylindrical housing.

3. The sorption module of claim 2, wherein the cylindrical housing has a length to diameter ratio in the range of 1.5-to-1 to 3-to-1.

4. The sorption module of claim 1, wherein the inlet opening is arranged on a first side of a lateral surface and the outlet opening is arranged on an opposite second side of the lateral surface.

5. The sorption module of claim 1, wherein the sorption module comprises a flow deflector for manipulating a gas stream through the sorption module, wherein the flow deflector is configured to homogenize the flow to the different sorbent beds in the sorption module.

6. The sorption module of claim 5, wherein the flow deflector comprises a flap support with at least one flap for controlling an air flow through the sorption module.

7. The sorption module of claim 1, wherein inlet channels fluidically connected to the inlet opening are formed between the sorbent beds and taper in the direction of flow starting from the inlet opening in the direction of the outlet opening.

8. The sorption module of claim 1, wherein two vertically adjacent sorbent beds are arranged parallel to each other.

9. The sorption module of claim 1, wherein two vertically adjacent sorbent beds are tilted at an angle of 2° to 10° relative to each other.

10. The sorption module of claim 1, wherein a filler is arranged in an edge region of the housing.

11. The sorption module of claim 1, wherein the sorbent bed support has a height which corresponds to one to two times its width.

12. The sorption module of claim 1, wherein the sorbent material is spherical and is present as fill in the sorbent beds.

13. A system for separating carbon dioxide from the ambient air, comprising a dryer, a sorption unit, and a conveyor for conveying a stream of air through the system, wherein the sorption unit has one or more sorption modules, comprising:
a housing with at least one inlet opening and at least one outlet opening;
a sorbent bed support arranged in the housing, which supports a plurality of sorbent beds filled with a sorbent material;
and closure flaps for closing the at least one inlet opening and the at least one outlet opening in the housing of the sorption module.

14. A method for separating carbon dioxide from ambient air with a sorption module comprising: a housing with at least one inlet opening and at least one outlet opening; a sorbent bed support arranged in the housing, which supports a plurality of sorbent beds filled with a sorbent material; and closure flaps for closing the at least one inlet opening and the at least one outlet opening in the housing of the sorption module, the method comprising:
conducting a gas stream through an inlet opening into the housing of the sorption module;
adsorbing the carbon dioxide contained in the gas stream;
closing the closure flaps in the housing of the sorption module; and
desorbing the carbon dioxide bound in the sorbent material.

15. The method for separating carbon dioxide from the ambient air of claim 14, wherein a gas stream is conducted through a sorbent bed from a bottom side to a top side or from a top side to a bottom side.

16. The system of claim 13, wherein the housing is configured as a cylindrical housing.

17. The system of claim 16, wherein the cylindrical housing has a length to diameter ratio in the range of 1.5-to-1 to 3-to-1.

18. The method of claim 14, wherein the housing is configured as a cylindrical housing.

19. The method of claim 18, wherein the cylindrical housing has a length to diameter ratio in the range of 1.5-to-1 to 3-to-1.

20. The method of claim 14, wherein the inlet opening is arranged on a first side of a lateral surface and the outlet opening is arranged on an opposite second side of the lateral surface.
